(19) United States
(12) Patent Application Publication
(10) Pub. No.: US 2008/0097967 A1
(43) Pub. Date: Apr. 24, 2008

(54) Method and apparatus for interactive distribution of digital content

(75) Inventors: Celite Milbrandt, Austin, TX (US); Safdar Asghar, Austin, TX (US); Bradley D. Kindig, San Diego, CA (US)

Correspondence Address: COOLEY GODWARD KRONISH LLP;ATTN: Patent Group, Suite 1100, 777 - 6th Street, NW, WASHINGTON, DC, 20001, US

(73) Assignee: Broadband Instruments Corporation, San Diego, CA (US)

(21) Appl. No.: 11/637,300

(22) Filed: Dec. 12, 2006

Related U.S. Application Data
(60) Provisional application No. 60/862,736, filed on Oct. 24, 2006.

(51) Int. Cl. G06F 17/30

(52) U.S. Cl. 707/3

(57) ABSTRACT

A method and apparatus for receiving and selectively storing digital content broadcasted through a communication channel via any transmission means, while interacting with said digital content in a content receiver unit. Digital content and associated metadata are received, associated metadata is analyzed, and then both are selectively stored based on such analysis. In one embodiment, current digital content is received and stored by the content receiver unit, while the oldest digital content is discarded, in a first in-first out (FIFO) fashion. In another embodiment, current digital content is received by a content receiver unit, metadata is analyzed in regards to content selection criteria in addition to available memory, and digital content and associated metadata is selectively stored based on such analysis. In still another embodiment of the present invention, metadata associated with selectively stored digital content is analyzed further for selective playback of said digital content.

### CROSS-REFERENCE TO RELATED APPLICATIONS

This application claims the benefit of U.S. Provisional Patent Application Ser. No. 60/862,736 filed on Oct. 24, 2006 which is herein incorporated by reference.

### FIELD OF THE INVENTION

The present invention relates to a system for digital content distribution. Generally, the invention relates to a method and apparatus for sending, receiving, and selectively storing digital content, more particularly to a method and apparatus enabling a user to interact with receiving, storing, and playing back digital content.

### BACKGROUND OF THE INVENTION

Currently, traditional broadcast mediums, such as AM, FM, television, and satellite radio, provide real-time broadcasts with suboptimal performance. The signals of the traditional broadcast mediums can be lost, interrupting the user's overall experience.

In addition, traditional broadcast mediums are generally passive. They offer too few opportunities for the user to customize and interact with the content. The user is allowed to choose the genre of media content they listen to or watch by selecting a particular station, but have no ability to customize the particular station to his or her preferences.

In an alternative to traditional broadcast mediums, one could download digital media files and purchase a traditional digital media player in order to customize and interact with digital content, but this results in unnecessary time and expense. In addition, digital media players are extremely limited in memory capacity, and the user must waste time manually deleting files in order to download additional ones.

### SUMMARY OF THE INVENTION

The present invention overcomes the shortcomings of the previous art by offering non-real time broadcasts in which the digital content is continuously streaming and being stored to provide the user with an interruption free experience.

In addition, the invention herein advantageously permits interaction of digital content by allowing the content unit receiver to customize the content received to user's input and/or user preferences. The invention also provides a better, more customized user experience without the hassle and expense of downloading media to a digital media player. Furthermore, the invention provides a seemingly unlimited memory capacity, since files are automatically updated either in a first-in, first-out fashion, in one embodiment, or based on the user's preferences, in another.

Thus, the invention herein is capable of interruption free playback, while organizing and sequencing content into a program similar to traditional programming, but allowing the user to actively tailor the content for their specific individual preferences. This invention herein delivers personalized content everywhere, unlike traditional broadcasting, effortlessly, unlike current digital media players.

It should be noted, the description of the invention set forth herein is illustrative, and does not limit the scope of the invention as set forth in the claims. It should be understood that those being skilled in the art will recognize variations and modifications of the embodiments disclosed herein are possible. For example, various forms of digital content could be broadcasted, such as digital audio, video, or data files, through various communication channels, including using a satellite, terrestrial transmission station, 802.11 wireless, or internet amongst other transmission means, to a variety of content unit receivers, e.g. portable devices, in-car units, or stationary equipment. These and other variations and modifications of the embodiments disclosed herein may be made without departing from the spirit of the invention and from the scope of the invention as set forth by the claims.

### BRIEF DESCRIPTION OF THE DRAWINGS

FIG. 1 illustrates general system architecture in accordance with the present invention.

FIG. 2 is a block diagram illustrating digital content distribution architecture in accordance with the present invention.

FIG. 3 is a block diagram of a content receiver unit in accordance with an embodiment of the present invention.

FIG. 4 shows an example of metadata to be utilized in content selection criteria according to an embodiment of the present invention.

FIG. 5 demonstrates a flow chart illustrating a method in accordance with an embodiment of the present invention.

FIG. 6 demonstrates a flow chart illustrating an additional method in accordance with an embodiment of the present invention.

FIG. 7 demonstrates a flow chart illustrating a method of monitoring digital content played in accordance with an embodiment of the present invention.

FIG. 8 illustrates a method of selecting content for storing to a storage medium according to an embodiment of the present invention.

FIG. 9 illustrates a method of selecting content for playback according to an embodiment of the present invention.

### DETAILED DESCRIPTION OF THE INVENTION

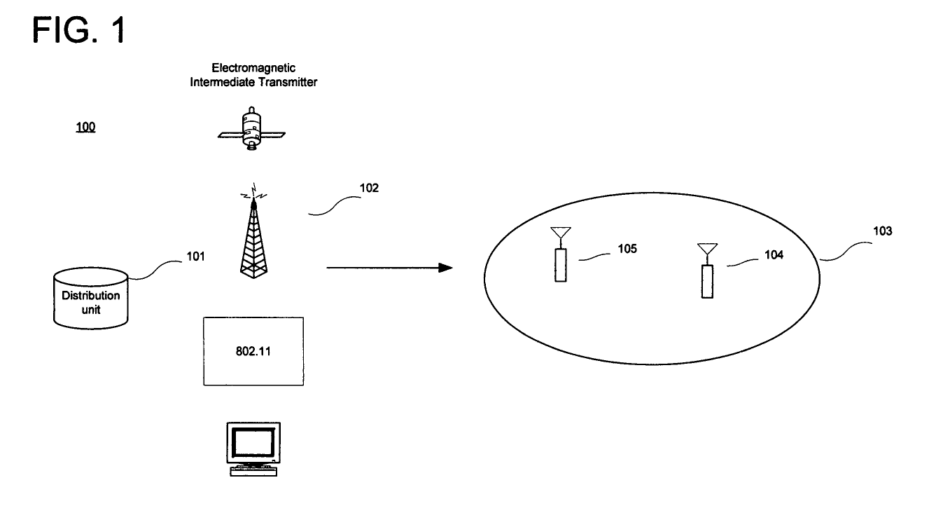

FIG. 1 illustrates general communication channel architecture 100 in accordance with an embodiment of the present invention. A distribution unit 101 transmits a digitally encoded bit stream, containing digital content and associated metadata, through a communication channel via any transmission means to an intermediate electronic transmitter 102, which could be a satellite, a terrestrial transmission station, or 802.11 wireless, amongst others. Said intermediate electronic transmitter then broadcasts digital content and associated metadata over a specific coverage area 103 which can be received and selectively stored by content unit receivers 104 and 105. As depicted in FIG. 1, the receivers in 104 and 105 can be located in automobiles, or other vehicles or can be handheld or stationary units for home or office use.

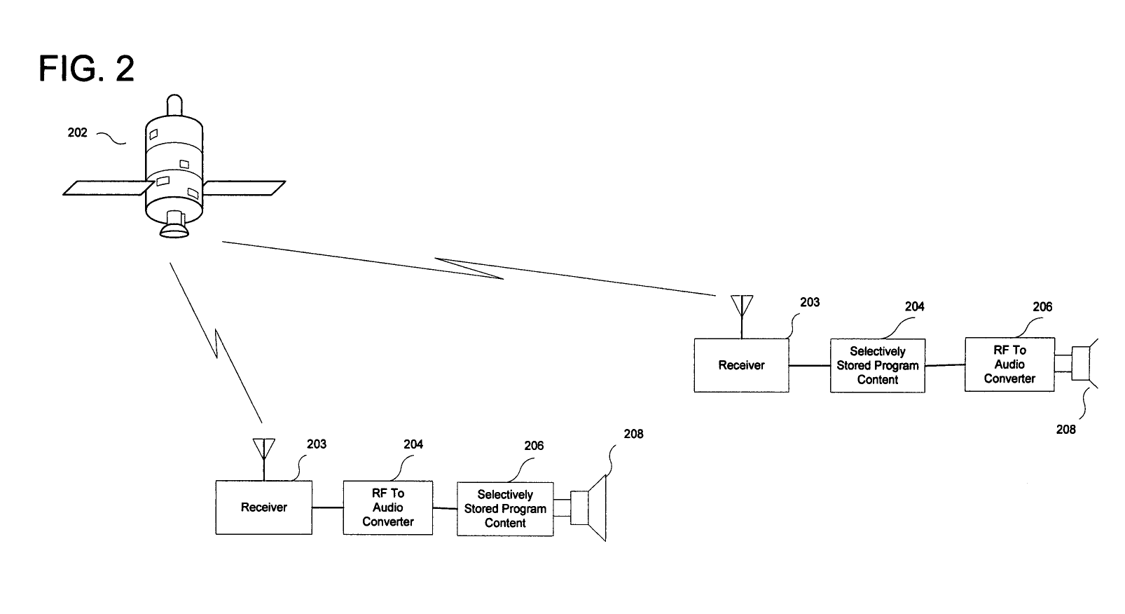

Referring to FIG. 2, a digital content distribution system 200 is shown in accordance with the present invention. The system 200 preferably comprises an intermediate electronic transmitter 202 to broadcast signals. The system 200 also preferably includes a plurality of content receiver units (104 and 105), each preferably having a receiver 203, a radio frequency to digital media converter 204, and selectively stored program content in a storage medium 206 available for playback via a digital media player 208.

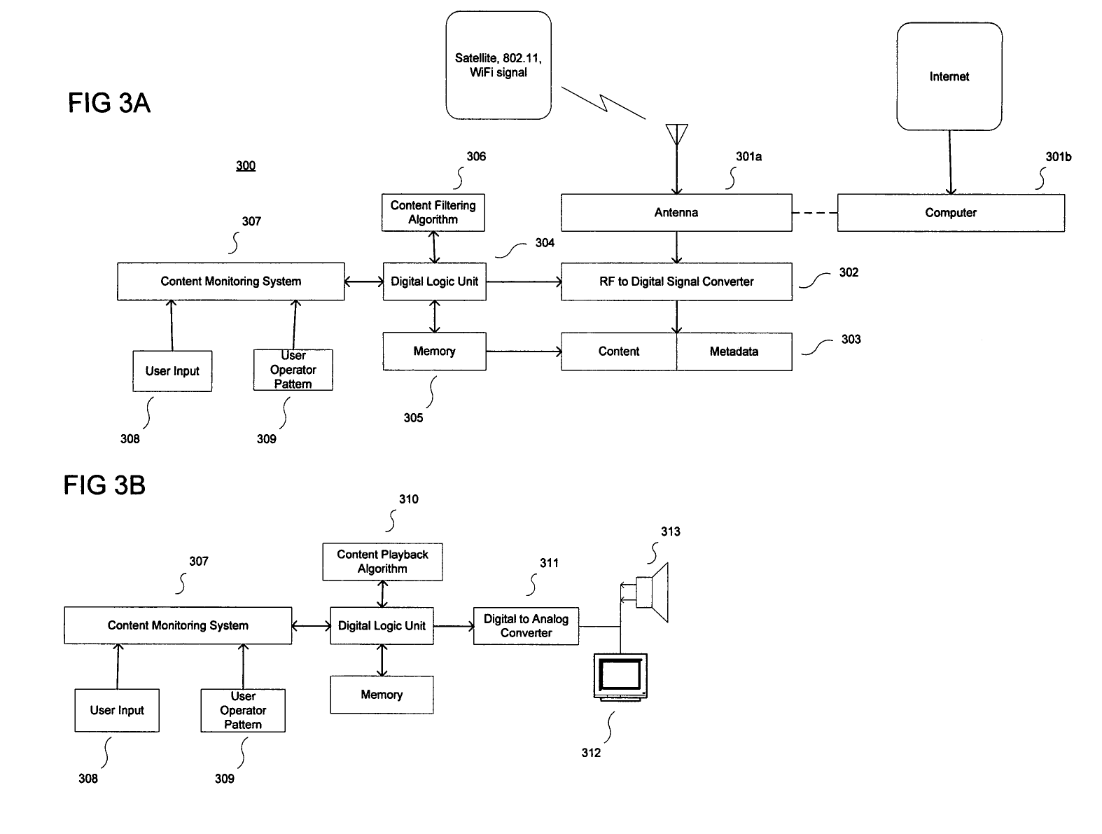

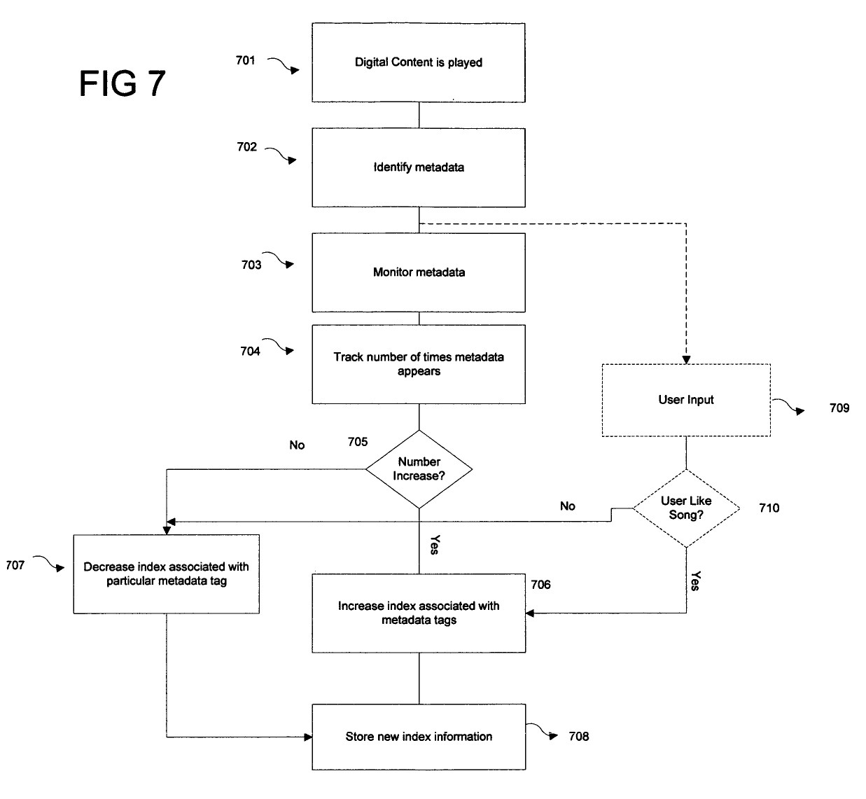

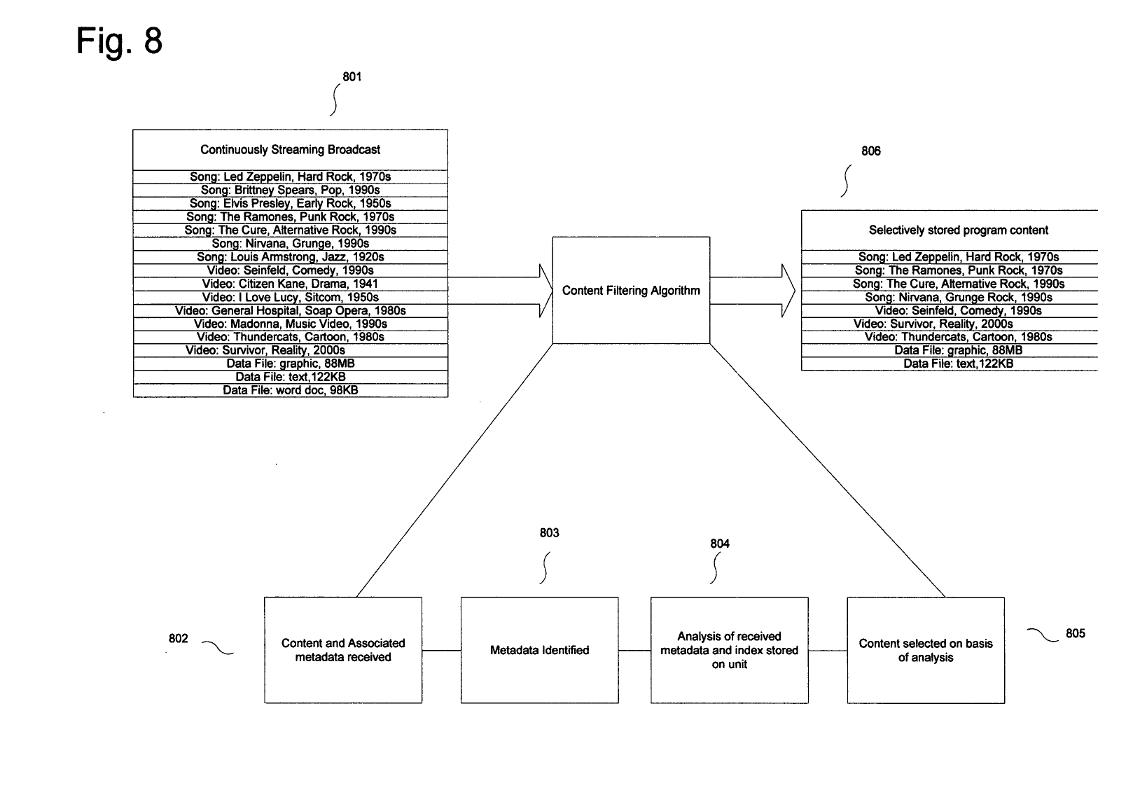

FIG. 3 is a block diagram of a typical content receiver unit 300 in accordance with the present invention. For receiving and storing digital content, 3A, the content receiver unit preferably comprises an antenna 301 for receiving a digital data stream. Said digital data stream received is converted to a digital signal 302, wherein the digital signal contains content and associated metadata 303. The content receiver unit preferably comprises a digital logic unit 304 that determines which content and associated metadata is stored in a storage medium 305, via a content filtering algorithm 306 as further detailed below in FIG. 8. Said content filtering algorithm 306 is created by a content monitoring system 307, as further detailed below in FIG. 7, which is based on various user inputs 308 and/or user operator patterns 309.

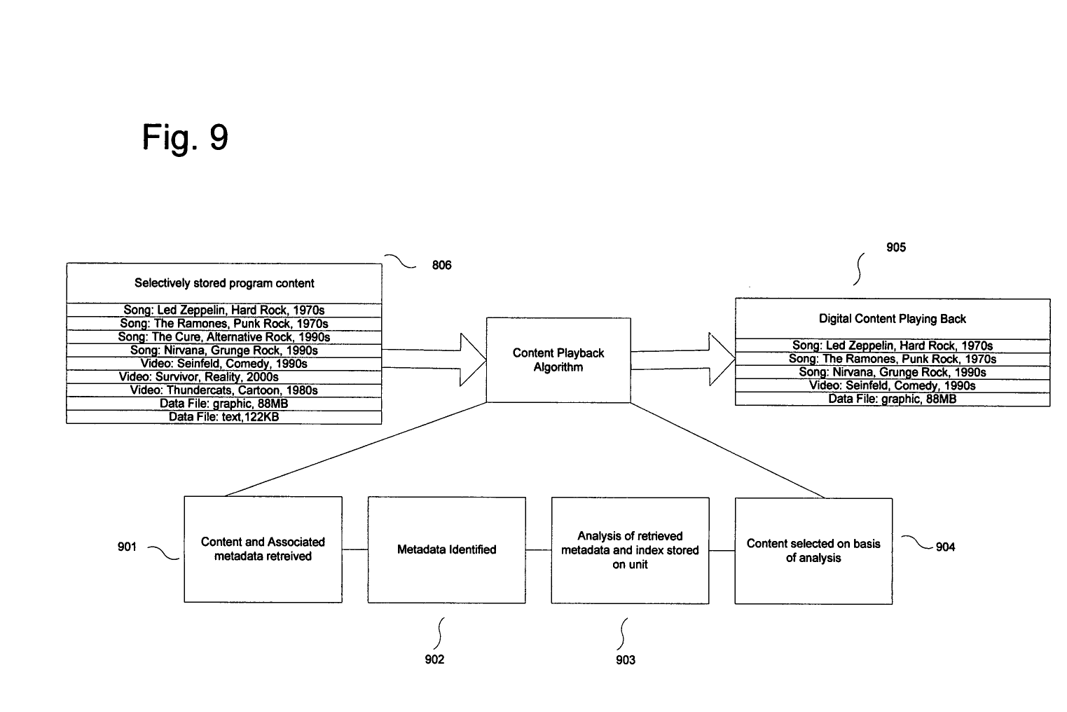

For playing back digital content, 3B, the content unit receiver preferably comprises an input selection device 308, such as a keypad. Said content monitoring system 307 monitors user input 308 and/or user operator patterns 309 to determine a content playback algorithm 310 as further diagramed in FIG. 9. Based on the content playback algorithm 310, a digital logic unit 304 determines which digital content is converted to media 311 either visually through a display 312 and/or audibly through an audio output device 313, such as a speaker.

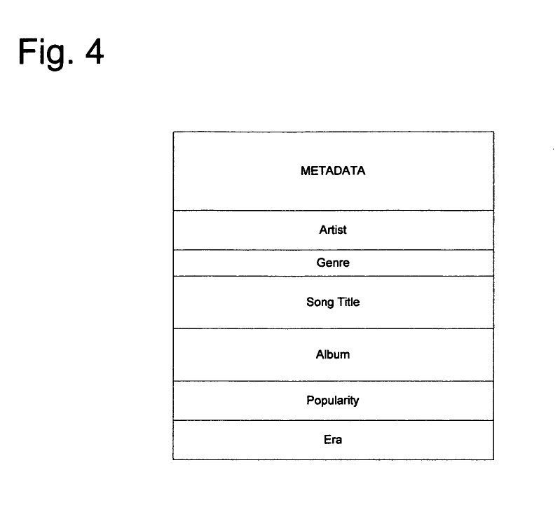

FIG. 4 illustrates just one example of associated metadata to be used in the selection criteria. It should be noted that the term “metadata” as used in respect with the present invention is defined in its broadest terms to mean any information associated with digital content, including but not limited to file size, genre, artist/author, song title, album, popularity, etc. and the information contained in the following example is only used as a reference to further explain an embodiment of the invention. As depicted as an example in FIG. 4, the following metadata is embedded in digital content: artist, genre, song title, album, popularity, and era. In order to mark, score, categorize, rate, etc. said digital content, a matrix is applied to each of the above categories and also embedded as metadata.

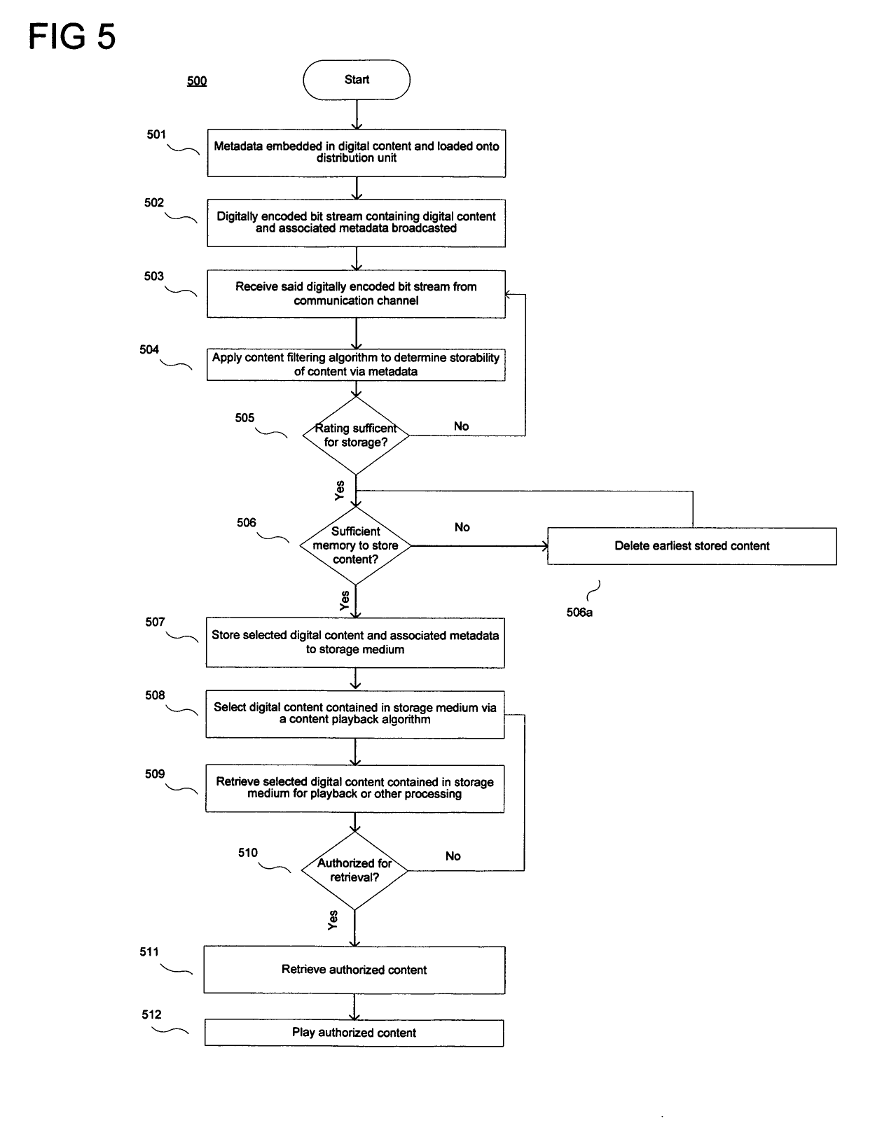

FIG. 5 shows a flow chart illustrating a method 500 of sending, receiving, and selectively storing digital content broadcasted. As explained in FIG. 4, at Step 501, metadata is embedded in digital content to mark, rate, categorize, score, etc. said digital content and then said digital content and associated metadata is loaded on to a distribution unit. At Step 502, said distribution unit transmits a digitally encoded bit stream over a communication channel via any transmission means, in which said digitally encoded bit stream contains digital content and associated metadata. At Step 503, said digitally encoded bit stream is received from said communication channel. At Step 504, the method applies said content filtering algorithm to determine the storability of the content via the metadata. As further detailed in FIG. 8, said content filtering algorithm is an analysis of metadata associated with received digital content and index on content unit receiver. If storable, at decision block 505, the method determines the storage medium's memory availability at decision block 506. If memory is available, then the method will proceed to store selected content and associated metadata to the storage medium, Step 507. If no memory is available, the earliest stored content is deleted at Step 506a, and the method returns to decision block 506. In Step 508, the method proceeds by selecting digital content contained in the storage medium for retrieval via a content playback algorithm, which said content playback algorithm is an analysis of stored content associated metadata and index on content unit receiver. In Step 509, the method retrieves selected digital content contained in the storage medium for playback and/or other processing. At decision block 510, the method determines if selected content is authorized for retrieval. If selected content is authorized for retrieval, then the method will retrieve authorized content as in Step 511. Step 512, authorized content is played.

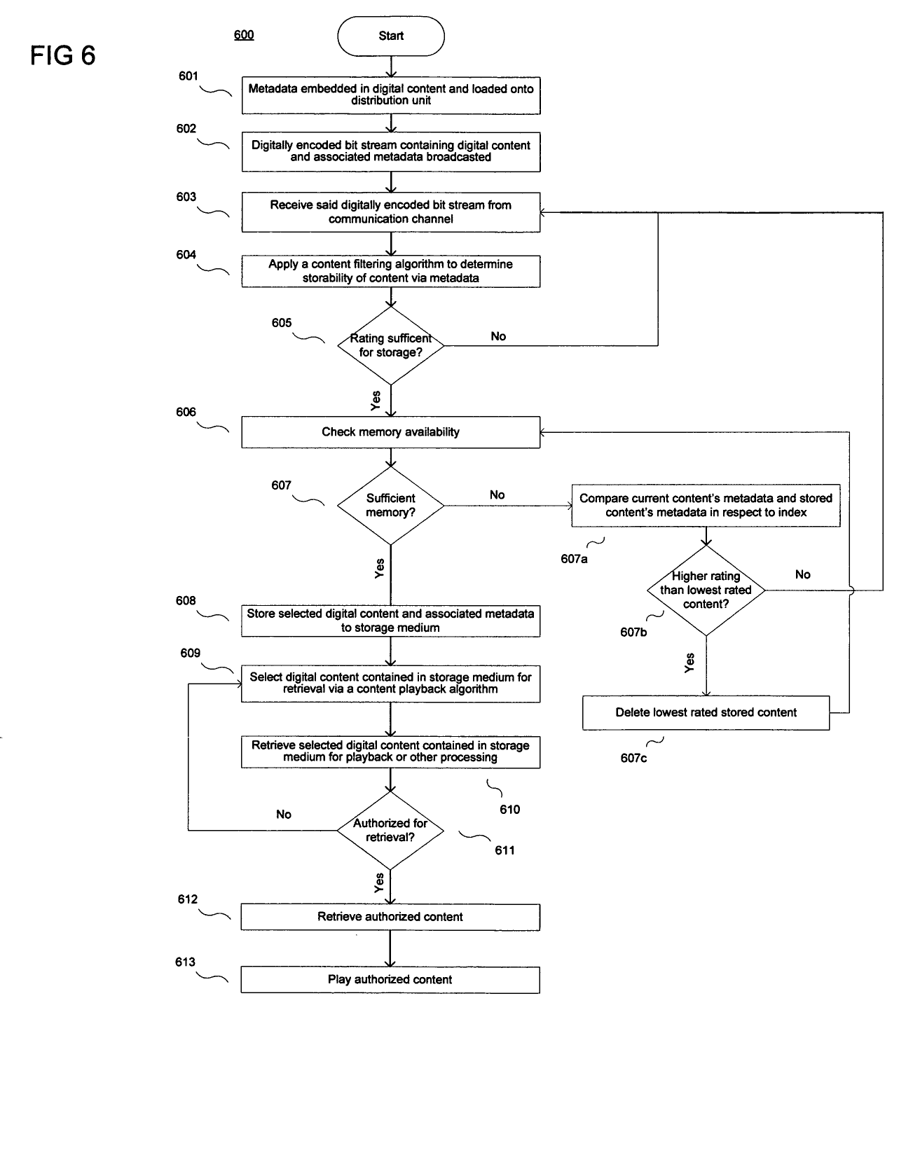

FIG. 6 shows a flow chart illustrating a method 600 in accordance with the present invention. Steps 601-603 are identical to Steps 501-503 from FIG. 5. Similar to Step 504, at Step 604, the method applies a content filtering algorithm to determine the storability of the content via the metadata. If storable, at decision block 605, the method determines the storage medium's memory availability at Step 606. At decision block 607, if sufficient memory is available, then the method will proceed to store selected content and associated metadata to a storage medium at Step 608. If sufficient memory is not available, then the method will proceed to compare the received content's metadata with the stored content's metadata in respect to the stored index at Step 607a. At decision block 607b, if the received content's metadata is higher then the lowest rated stored content, then the lowest rated stored content will be discarded, Step 607c, and the method returns to decision block 607. With Steps 609-613, the method proceeds identically as in Steps 508-512 from FIG. 5.

FIG. 7 demonstrates a flowchart of one method 700 of how content is monitored in a content monitoring system with respect one embodiment to the present invention. In Step 701, digital content is played by user. In Step 702, the embedded metadata of played digital content is identified and monitored along with all embedded metadata in Step 703. The number of times metadata appears is tracked as shown in Step 704. In decision block 705, if the number of times particular metadata appears increases, then the index associated with that metadata will increase 706, otherwise the index associated with metadata will decrease. In another embodiment, in Step 709, said user enters input indicating their preference for said digital content played in Step 701. In decision block 710, if user indicates favorable preference for said content played, the index associated with the particular metadata increases 710. If user indicates a negative review for said digital content played, then the index associated with the particular metadata decreases 707. In either embodiment, as shown in Step 708, new index information is stored.

FIG. 8 illustrates a method of selecting content for storing 800 to a storage medium according to an embodiment of the present invention. Continuously streaming broadcast containing content and associated metadata 801 is received 802 by a content unit receiver. Associated metadata is identified 803 and analyzed according to its index 804. As detailed in FIG. 7, said index is determined by user operator preferences and/or user input. Based on analysis of associated metadata, digital content is selected for storage 805. The method then proceeds to store digital content and associated metadata to a storage medium 806.

FIG. 9 illustrates a method of selecting content for play back 900 according to an embodiment of the present invention. Associated metadata is retrieved from a storage medium 901, identified 902 and analyzed according to its index 903. Based on analysis of associated metadata, digital content associated with particular metadata is selected and retrieved for playback 904. The method then proceeds to play digital content 905.

What is claimed:

1. A system for receiving and processing digital content, said system comprising:
a receiver unit operative to receive digital data stream, said digital data stream containing digital content and associated metadata;
a content selection module operative to monitor said digital content and said associated metadata and based on said monitoring generate content selection criteria, and selectively identify said digital content and said associated metadata consistent with content selection criteria; and
a storage medium in which are stored said content and said associated metadata consistent with content selection criteria.

2. The system of claim 1, further comprising a content removal module operative to remove said content stored in said storage medium wherein said removal is based at least in part on a first-in, first-out method.

3. The system of claim 1, further comprising a content removal module operative to remove said content stored in said storage medium wherein said removal is based at least in part on said content selection criteria.

4. The system of claim 1, further comprising a user input module operative to enable a user to provide an input to said system.

5. The system of claim 4, further comprising said content selection module operative to monitor said input and based on said monitoring generate content selection criteria.

6. The system of claim 1, further comprising a content retrieval module operative to retrieve said digital content from said storage medium.

7. The system of claim 6, said content retrieval module further operative to retrieve said digital content from said storage medium, wherein said content retrieved is based on content selection criteria.

8. The system of claim 6, further comprising a playback module operative to playback said digital content retrieved from said storage medium.

9. The system of claim 7, further comprising a playback module operative to playback said digital content retrieved from said storage medium, said content played consistent with content selection criteria.

10. A method for receiving and processing digital content, said method comprising:
receiving a digital data stream, said digital data stream containing digital content and metadata,
selectively identifying, based at least in part on said metadata, said content consistent with content selection criteria;
storing said content consistent with content selection criteria in a storage medium; and
monitoring, based at least in part on said metadata, said content to generate said content selection criteria.

11. The method of claim 10, in which the method further comprises removing said content stored in said storage medium, in which said content removed is based at least in part on a first-in, first out manner.

12. The method of claim 10, in which the method further comprises removing said content stored in said storage medium, in which said content removed is based at least in part on content selection criteria.

13. The method of claim 10, in which the method further comprises enabling a user to provide input.

14. The method of claim 13, in which said input directly generates content selection criteria.

15. The method of claim 13, in which the method further comprises monitoring said input and based on said monitoring generate content selection criteria.

16. The method of claim 10, in which the method further comprises retrieving said digital content from said storage medium.

17. The method of claim 10, in which the method further comprises retrieving said digital content from said storage medium, said content retrieved based on content selection criteria.

18. The method of claim 16, in which the method further comprises playing back said digital content retrieved from said storage medium.

19. The method of claim 17, in which the method further comprises playing back said digital content retrieved from said storage medium, said content played back based on content selection criteria.

20. A device for receiving and processing digital content, said device comprising of:
an antenna operative to receive a digital data stream, said digital data stream containing digital content and metadata;
a decoder operative to decode said digital data stream received;
a radio frequency to digital converter module operative to access said digital content and associated metadata from said digital data stream received;
a storage medium in which are stored said content and said associated metadata consistent with content selection criteria; and
a content selection module operative in part to monitor said content and said associated metadata and based on said monitoring to generate content selection criteria.

21. A device as in claim 20, further comprising a content removal module operating in part to remove said content stored in said storage medium, wherein said content removed is done so on a first-in, first out manner.

22. A device as in claim 20, further comprising a content removal module operating in part to remove said content stored in said storage medium, wherein said content removed is consistent with content selection criteria.

23. A device as in claim 20, further comprising a digital to media converter to access said content and associated metadata for retrieval.

24. A device as in claim 23, further comprising of an audio output device, such as a speaker.

25. A device as in claim 23, further comprising of a visual output device, such as a television or a computer monitor.

26. A device as in claim 20, further comprising of an input selection device, such as a keypad.

27. A device as in claim 26, wherein said content selection module further operates in part to monitor user input and based on said monitoring generate content selection criteria.

28. A machine readable medium having instructions stored thereon for execution by a processor to perform a method of processing digital content comprising:
receiving a digital data stream wherein said digital data stream includes digital content and metadata;
selectively identifying, based at least in part on said metadata, portions of said content consistent with content selection criteria;
storing said content and said associated metadata in a storage medium; and
monitoring said content and said associated metadata and based on said monitoring generate content selection criteria.

29. The machine readable medium of claim 28, wherein the instructions stored thereon further comprise routinely removing said content selectively stored in a storage medium, in which said content removed is based at least in part on a first-in, first out manner.

30. The machine readable medium of claim 28, wherein the instructions stored thereon further comprise routinely removing said content selectively stored in said storage medium, in which said content selectively removed is based at least in part on said content selection criteria.

31. The machine readable medium of claim 28, wherein the instructions stored thereon further comprise monitoring various user inputs to generate said content selection criteria.

32. The machine readable medium of claim 28, wherein the instructions stored thereon further comprise retrieving said digital content from said storage medium, said content retrieved consistent with content selection criteria.

33. The machine readable medium of claim 28, wherein the instructions stored thereon further comprise playing back said digital content retrieved from said storage medium, said content played back consistent with content selection criteria.

34. A system for distributing digital content, said system comprising:
a distribution unit operative to broadcast a digital data stream, said digital data stream containing digital content and associated metadata;
a receiver unit operative to receive digital data stream, said digital data stream containing digital content and associated metadata;
a content selection module operative to monitor said digital content and said associated metadata and based on said monitoring generate content selection criteria, and selectively identify said digital content and said associated metadata consistent with content selection criteria; and
a storage medium in which are stored said content and said associated metadata consistent with content selection criteria.
